(19) United States
(12) Patent Application Publication
(10) Pub. No.: US 2014/0197226 A1
(43) Pub. Date: Jul. 17, 2014

(54) METHODS FOR DETERMINING A MINIMUM WELD DISTANCE FOR ADHESIVES

(71) Applicant: Ford Global Technologies, LLC, Dearborn, MI (US)

(72) Inventors: Sanjay Mehta, Plymouth, MI (US); Xiaoming Chen, Canton, MI (US); John Martin Knittel, Canton, MI (US); Jeff A. Wallace, Walled Lake, MI (US)

(73) Assignee: Ford Global Technologies, LLC, Dearborn, MI (US)

(21) Appl. No.: 13/744,311

(22) Filed: Jan. 17, 2013

(51) Int. Cl. B23K 31/12

(52) U.S. Cl. CPC B23K 31/12
USPC 228/103

(57) ABSTRACT

A method of manufacturing a vehicle frame assembly, includes: (i) receiving threshold temperature data for an adhesive; (ii) defining an adhesive zone wherein which adhesive will be applied with respect to a first and second vehicle structural member; and (iii) determining a minimum distance a weld can be applied on the first structural member with respect to the adhesive zone based on empirical data.

### CROSS-REFERENCE TO RELATED APPLICATIONS

This application is a continuation and claims the benefit of U.S. patent application Ser. No. 13/221,142 titled “Vehicle Support Frames with Interlocking Features for Joining Members of Dissimilar Materials” filed Aug. 30, 2011 and U.S. patent application Ser. No. 13/545,584 titled “Vehicle Support Frames with Interlocking Features for Joining Members of Dissimilar Materials” filed Jul. 10, 2012, which are hereby incorporated by reference in their entirety.

### TECHNICAL FIELD

The present disclosure relates to methods of manufacturing structural assemblies using adhesives and welding, in particular vehicle frame assemblies.

### BACKGROUND

Conventional vehicle support frames can be composed of different materials including, for example, steel, aluminum and reinforced polymer composites. Vehicle manufacturers attempt to strike a balance between weight reduction and structural rigidity. It is desirable to design lightweight vehicle frames for full-sized light trucks. Aluminum structural members can be designed to achieve up to a 50% weight reduction while still meeting performance targets. Joining aluminum members to steel frame rails presents challenges.

Alternative methods for joining together rails composed of different materials in frame assemblies include the use of adhesives. Adhesives provide structural reinforcement between two components but some adhesives have thermal thresholds that cannot be exceeded. When welding not only the weld line gets hot but surrounding components can see hotter temperatures.

Therefore, it is desirable to have techniques for applying welds in vehicle frame assemblies that incorporate the use of adhesive(s). A minimum weld-distance away from which a weld can be applied with respect to an adhesive is desirable for manufacturing vehicle frame assemblies of different configurations and material compositions.

### SUMMARY

The present disclosure addresses one or more of the above-mentioned issues. Other features and/or advantages will become apparent from the description which follows.

One advantage of the present disclosure is that it provides improved manufacturing techniques for vehicle frame assemblies utilizing welded joints and adhesive. Frame assemblies can be of different configurations or differing material compositions. A bright-line minimum weld-distance is determined to govern adhesive placement with respect to the weld.

Such techniques are particularly useful in vehicle frames composed of different material. Another advantage of the present disclosure is that it teaches the manufacture and use of light-weight vehicle structural frames that can be utilized with vehicles of different sizes, including full-sized truck frames. The weight reduction for the disclosed frame assemblies compared to contemporary structural frames can be as great as 50%. Fuel efficiency and performance can be enhanced by the use of the disclosed frame assemblies.

One exemplary embodiment of the present disclosure relates to a method of manufacturing a vehicle frame assembly, the method includes: (i) receiving threshold temperature data for an adhesive; (ii) defining an adhesive zone wherein which adhesive will be applied with respect to a first and second vehicle structural member; and (iii) determining a minimum distance a weld can be applied on the first structural member with respect to the adhesive zone based on empirical data.

Another exemplary embodiment of the present disclosure relates to a method of determining a minimum weld distance from which a weld can be applied with respect to adhesive in a vehicle frame assembly, the method including: (i) measuring temperatures of the adhesive during welding at a plurality of distances away from the weld; (ii) receiving threshold temperature data for the adhesive; and (iii) selecting one of the plurality of distances as a minimum weld distance from which adhesive should be applied with respect to the weld for the vehicle frame assembly based on temperature measurements and the threshold temperature data.

Another exemplary embodiment of the present disclosure relates to a method of determining a minimum weld distance from which a weld can be applied with respect to adhesive in a plurality of vehicle frame assemblies, the method includes: (i) receiving dimensional data and material composition data for a side rail, a cross-rail, and an interconnecting member in each vehicle frame assembly; (ii) measuring temperatures of the adhesive during welding at a plurality of distances away from the weld; and (iii) selecting one of the plurality of distances as a minimum weld distance from which adhesive should be applied with respect to the weld for each vehicle frame assembly based on temperature measurements and the threshold temperature data.

Joining vehicle frame assembly rails composed of dissimilar materials using welding and adhesives will be explained in greater detail below by way of example with reference to the figures, in which the same reference numbers are used in the figures for identical or essentially identical elements. The above features and advantages and other features and advantages of the present teachings are readily apparent from the following detailed description of the best modes for carrying out the invention when taken in connection with the accompanying drawings. In the figures:

### BRIEF DESCRIPTION OF THE DRAWINGS

FIG. 1 is a top, partial perspective view of a vehicle support frame assembly.

FIG. 2 is a perspective view of the vehicle support frame assembly of FIG. 1 with thermocouples attached thereto.

FIG. 3 is a perspective view of the vehicle support frame assembly of FIG. 2 at circle 3.

FIG. 4 is a plot of temperature over time for a vehicle support frame assembly as measured at a number of locations with respect to the assembly of FIG. 1.

### DETAILED DESCRIPTION

Referring to the drawings, wherein like characters represent examples of the same or corresponding parts throughout the several views, there is shown a vehicle support frame having joined structural members composed of different materials. The exemplary illustrated frame assembly employs multiple joining processes for fortifying the assembly. Welding, adhesives and a mechanical interlock (e.g., crimping) are used on the illustrated embodiment. Vehicle frame is used to test the surface temperature of various structural components during welding. The test data is compiled to provide a minimum weld distance that any adhesive should be placed away from the weld during the assembly or manufacturing process.

An advised minimum weld distance can be determined using a number of different techniques. In one embodiment, an advised minimum weld distance is determined empirically. A series of thermocouples are positioned with respect to the frame assembly during welding. Given the weld temperature data received, a minimum weld distance is identified. Minimum weld distance can be referenced using a look-up table, line graph or a formula, some examples of which are discussed hereinbelow.

The teachings herein are applicable to any type of frame, especially vehicle frames including frames for pickup trucks, vans, minivans, sports utility vehicles, sedans, coupes, commercial vehicles, and all utility vehicles.

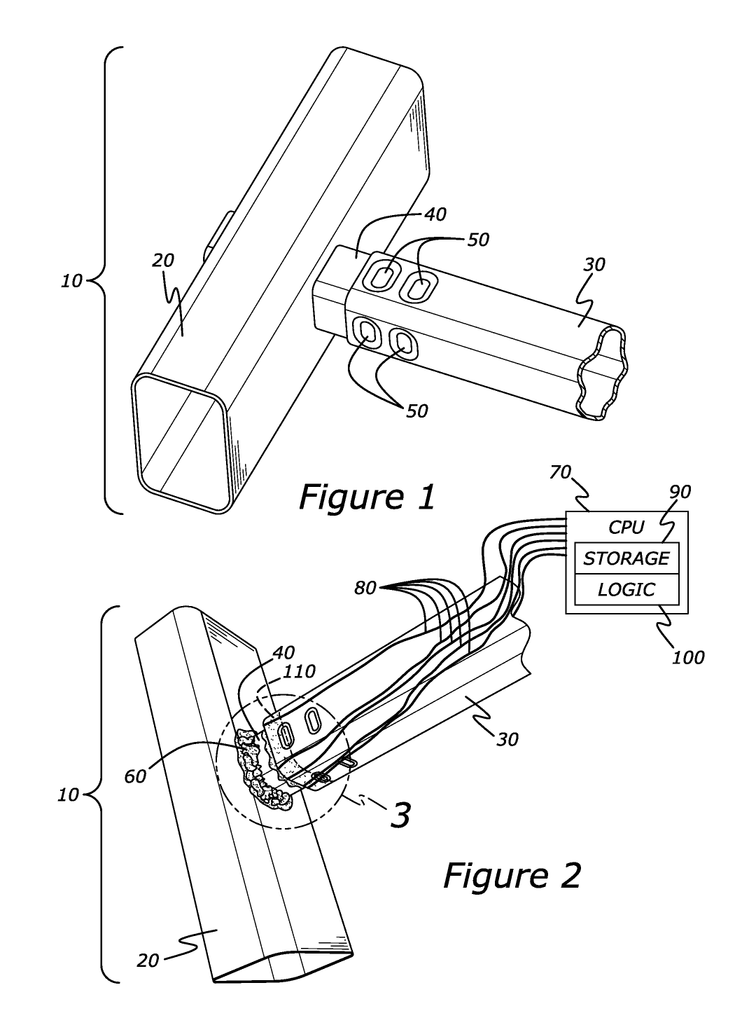

Referring now to FIG. 1, there is shown therein a partial perspective view of a vehicle cross-member assembly (or support frame) 10. The illustrated cross-member assembly 10 is configured for use in a pickup truck. Cross-member assembly 10 (as shown) is taken from the rear section of a truck frame, which supports a truck bed (not shown). Assembly 10 is a support frame. A side rail 20 extends longitudinally with respect to the assembly 10 and the vehicle. In the shown embodiment, side rail 20 is composed of steel and can be formed via any standard forming process, e.g., stamping, hydro-forming, or roll forming. A rail 30 (or cross-rail) is positioned perpendicularly with respect to rail 20. Rail 30 is composed of aluminum in this embodiment. The material used for side rail 20 is not weld compatible with the material used for the rail 30, thus rail 30 is fitted with an interconnecting member 40, as discussed hereinbelow. In this embodiment, interconnecting member is composed of steel. Rail 30 is mechanically interlocked with interconnecting member 40 and ICM is welded to rail 20. As discussed below, in this embodiment, adhesive is used to attach the interconnecting member 40 to rail 30. Interconnecting member 40 is also crimped to form crimps 50 in rail 30 for an alternative mechanical interlock. Two sets of crimps 50 are formed on each wall of the cross-rail 30 and ICM 40. As shown in FIG. 1, interconnecting member (or “ICM”) 40 passes through side rail 20 at a 90 degree angle or perpendicularly.

The diagram of FIG. 1 illustrates the vehicle frame assembly 10 pre-welding. In FIG. 2, a weld line (or surface) 60 is shown at the intersection of ICM 40 and side rail 20. Weld line 60 is a complete weld traversing 360 degrees with respect to an outer surface of the ICM 40. Weld line 60 is applied in two directions, 180 degrees clockwise with respect to cross rail 30 and 180 degrees counterclockwise with respect to the same. Weld in weld line 60 is applied via a MIG welding process in this embodiment. In other embodiments, laser welding, soldering, brazing or other processes can be used.

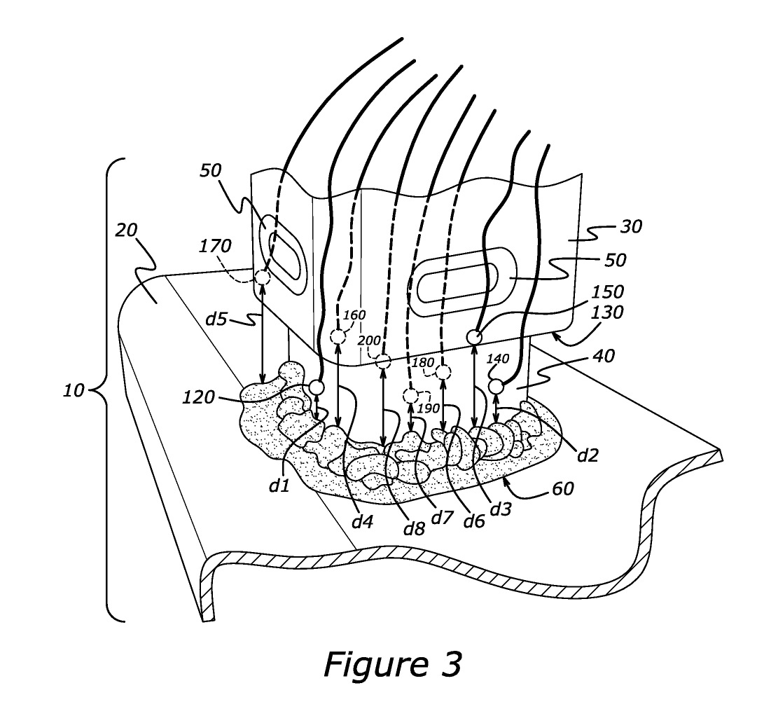

In preparation for a test to determine a minimum weld distance for the shown vehicle frame assembly, a series of thermocouples are attached to cross-rail 30 and ICM 40, as shown in FIG. 2. Thermocouples, as shown in FIG. 3, are connected to a processing unit 70 via leads or wires 80. The central processing unit (or CPU) 70 includes memory 90 for recording the temperatures of each thermocouple during welding. CPU 70 further includes determination logic 100 for selecting one of a plurality of distances from which thermocouples are placed away from weld line as a minimum weld distance for application of adhesive given the measured temperatures received during testing.

A layer of adhesive 110 is shown in phantom in FIG. 2 between the cross rail 30 and ICM 40. Adhesive is also applied outside of the cross rail 30, as shown. The area to which adhesive is applied defines an adhesive zone.

An exemplary method of determining a minimum weld distance from which a weld can be applied with respect to adhesive in a plurality of vehicle frame assemblies, includes the following steps: (i) receiving dimensional data and material composition data for a side rail (e.g., 20 as shown in FIGS. 2-3), a cross-rail (e.g., 30), and an interconnecting member (e.g., 40) in each vehicle frame assembly; (ii) measuring temperatures of the adhesive during welding at a plurality of distances away from the weld; and (iii) selecting one of the plurality of distances as a minimum weld distance from which adhesive should be applied with respect to the weld for each vehicle frame assembly based on temperature measurements and the threshold temperature data.

The second step—measuring temperatures of the adhesive during welding at a plurality of distances away from the weld—is further illustrated with respect to FIG. 3. FIG. 3, is a perspective view of the assembly 10 of FIG. 2, taken at circle 3 with the adhesive zone 110 removed. Various thermocouple placements are illustrated in FIG. 2. As shown in FIG. 2, eight thermocouples are placed at various distances away from weld line 60. Temperatures are measured during welding. Thermocouple 120 is placed on an exterior surface of ICM 40. The distance between thermocouple 120 and the weld line 60 is defined by a distance equal to d1. “Distance” in this test refers to the length with respect to a longitudinal axis of the ICM or cross rail. In another embodiment distance refers to the length of the shortest possible line between the thermocouple and the weld or a welded line 60. In this manner, distance can be measured across more than one dimension of the ICM 40, side rail 20 or cross rail 30. In other embodiments data related to distance or a minimum weld distance can be recorded in two or three dimensions, e.g., in a vector format. Also distance can be solved for by measuring a length from an edge 130 of cross rail 30 and knowing the distance between the edge of the cross rail to the weld line 60. In this embodiment, d1 is equal to ½″ but d1 can be greater or lesser in other tests. Another thermocouple 140 is placed on the exterior surface of ICM 40. Thermocouple 140 is placed on a wall running perpendicular to the wall in which thermocouple 120 is attached. Thermocouple 140 is positioned a distance equal to d2 away from the weld line 60 between side rail 20 and ICM 40. In this embodiment, d2 is equal to 1/2″ but d2 can be greater or lesser in other tests.

Thermocouple 150, as shown in FIG. 3, is placed on an exterior surface of cross rail 30. Thermocouple 150 is proximate to an edge 130 of cross rail 30, e.g., 2 mm away from the edge of cross rail. Thermocouple 150 is placed a distance of d3 away from weld line 60, which is 1″ away from weld line. In other embodiments, d3 can be greater or less than an inch. Two additional thermocouples 160, 170 are located on an interior surface of cross rail. Thermocouple 160 is located in a corner of cross rail 30. Thermocouple 160 is placed in adhesive between the aluminum cross rail 30 and steel ICM 40. Thermocouple 160 is approximately ½″ away from an edge 130 of cross rail 30. Thermocouple 160 is a distance of d4 away from weld line 60. In this embodiment, d4 equals 1.5″ but can be greater or fewer in other embodiments. Thermocouple 170 is located in another corner of cross rail 30. Thermocouple 170 is placed in adhesive between the aluminum cross rail 30 and steel ICM 40. Thermocouple 170 is approximately ½″ away from an edge 130 of cross rail 30. Thermocouple 170 is a distance of d5 away from weld line 60. In this embodiment, d5 equals 1.5″ but can be greater or fewer in other embodiments. On average, thermocouples 160, 170 positioned in adhesive showed lower temperatures than thermocouples placed on a surface of the cross rail 30 or ICM 40.

As shown in phantom lines in FIG. 3, three thermocouples 180, 190 and 200 are positioned on an inside surface of the steel ICM 40. Thermocouple 180 is located on an inside surface of ICM 40. Thermocouple 180 is approximately ½″ away from an edge 130 of cross rail 30. Thermocouple 180 is a distance of d6 away from weld line 60. In this embodiment, d6 equals ½″ but can be greater or fewer in other embodiments. Thermocouple 190 is located on an inside surface of ICM 40. Thermocouple 190 can also be positioned directly opposite thermocouple 140. Thermocouple 190 is approximately ½″ away from an edge 130 of cross rail 30. Thermocouple 190 is a distance of d7 away from weld line 60. In this embodiment, d7 equals ½″ but can be greater or fewer in other embodiments. Thermocouple 200 is positioned on an inside surface of ICM 40 at the juncture of ICM 40 and the edge 130 of cross rail 30. Thermocouple 200 is a distance of d8 away from weld line 60. In this embodiment, d8 equals 1″ but can be greater or fewer in other embodiments.

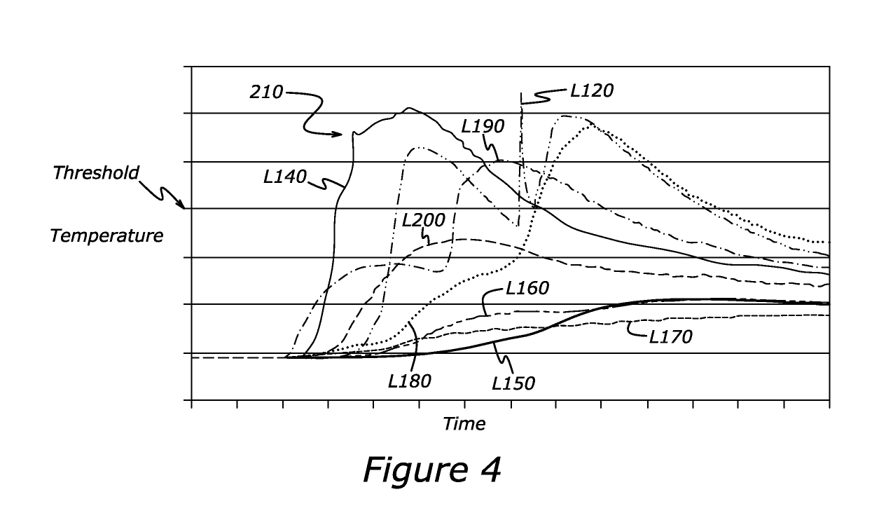

Thermal measurements are received and plotted over time, e.g., as shown in graph 210 of FIG. 4. FIG. 4 illustrates thermocouple temperatures over time. Weld data can be communicated to CPU for use in estimating a minimum weld distance. Weld data includes, for example the time of weld or the type of weld. Typically welding lasts between 1-3 seconds. In the illustrated embodiment, the weld lasted approximately 1.5 seconds. Each thermocouple temperature recording is plotted over time (as shown by lines L120, L140, L150, L160, L170, L180, L190 and L200 for thermocouples 120, 140, 150, 160, 170, 180, 190 and 200, respectively). Measured temperatures ranged from 100 degrees F. to 650 degrees F. The highest temperature is noticed at thermocouple 120 (as expressed by L120) positioned ½″ away from weld line on the exterior of the ICM (as shown in FIG. 3). A threshold temperature for the adhesive is marked as “Threshold.” In one embodiment, a threshold temperature for adhesive is 400 degrees Fahrenheit. Other adhesives can be used including, for example, resins or epoxies. The threshold temperature for the adhesive can be greater than or lower than 400 degrees F.

Thermocouples 150, 160, 170 and 200 do not show readings of temperatures in excess of the threshold temperature. Thermocouples 150, 160, 170 and 200 were placed 1″ (between the ICM and cross rail), 1.5″ from the weld line (between the cross rail and ICM), 1.5″ (between the ICM and cross rail) and 1″ (on inside surface of ICM) with respect to the weld line. Temperatures seen were less than 180 F, less than 210 F, less than 210 F and less than 330 F, respectively. Accordingly, a minimum weld distance for this embodiment is greater than or equal to the smallest of these numbers 1″ or roughly 25 millimeters from an adhesive (application) zone. A minimum distance can be greater for adhesive applied on an inner surface of ICM or between ICM and cross rail.

Thermocouples 120, 140, 180 and 190 did show readings of temperatures in excess of the threshold, as shown in the plot of FIG. 4, as shown in lines L120, L140, L180 and L190, respectively. Thermocouples 120, 140, 180 and 190 were placed ½″ (on an exterior surface of the ICM), ½″ (on the exterior of the ICM), ½″ (on an interior surface of ICM) and ½″ (on an interior surface of ICM) away from weld line 60, respectively. Accordingly, a weld distance equal to their placement is not preferable for this type of adhesive. Thermocouple 120 is placed on a top surface of ICM. Since each weld line 60 concludes at a top of ICM 40 this thermocouple saw the largest temperatures, as shown by line L120.

By assessing the minimum weld distance, ICM dimensions can be calculated or determined. For example, for the illustrated embodiment an ICM length for the vehicle frame assembly will need to be the minimum weld distance plus any overlap between the cross rail and ICM. In this way, frame dimensions and material savings can be seen.

In another embodiment of the method of determining a minimum weld distance, dimensional data with respect to the components of the vehicle frame assembly is received. The data includes receiving a length, thickness and width for the side rail, cross-rail or interconnecting member. For example, thicker or wider cross rails can be used, as such the minimum weld distance can change. Tests for vehicle assemblies of various configurations can provide a reference table for adhesive placement.

Other guiding factors can include material composition data for the structural components of the vehicle frame assemblies. The data can include a material conductivity rating (thermal or electrical). It will be appreciated that some materials have a higher thermal conductivity rating than others. Materials such as iron, low carbon steel, stainless steel, tungsten, titanium, magnesium, aluminum and copper have different thermal conductivity ratings at room temperature. Composites of these materials or others have various thermal conductivity ratings as well. A minimum weld distance for a vehicle frame assembly can be influenced by material selections and the thermal conductivity of said materials. A series of tests, similar to the aforementioned can be performed on vehicle frame assemblies of different material compositions to determine a minimum weld distance for those assemblies.

Other criteria for determining a minimum weld distance for adhesive can include weld data, e.g., weld time or type of weld. For larger frames, for example, weld time can be increased to three or four seconds. As such, the temperatures seen at each location shown in FIG. 3 can increase. Therefore, determination logic includes a setting for weld time. For frames requiring a higher or lower weld time than the standard configuration, tests can be performed over time at various locations in the frame assembly thereby determining a minimum weld distance for those assemblies.

A method of manufacturing a vehicle frame assembly can be implemented based on the present teachings. The method, in one embodiment, pertains to a vehicle frame assembly (e.g., 10 as shown in FIG. 1) that includes joints welded together and joints attached with adhesive. The method includes the following steps: (i) receiving threshold temperature data for an adhesive (e.g., 300 F per the adhesive manufacture label); (ii) defining an adhesive zone (e.g., 110 as shown in FIG. 2), in which adhesive will be applied with respect to a first and second vehicle structural member (e.g., 20 and 30 as shown in FIG. 1); and (iii) selecting one of the plurality of distances as a minimum distance a weld can be applied on the first structural member with respect to the adhesive zone based on empirical data. Exemplary methods of determining or selecting a minimum distance a weld can be applied are discussed hereinabove.

After selecting the minimum weld distance an operator can apply a weld at least the minimum distance away from the adhesive (application) zone thus placing the weld at least the minimum distance away from the adhesive zone. In a secondary mechanical interlocking procedure the vehicle structural members can be crimped together thereby causing adhesive to ooze therebetween, e.g., as shown in FIG. 1 and described in U.S. application Ser. No. 13/545,584 titled “Vehicle Support Frames with Interlocking Features for Joining Members of Dissimilar Materials” which has been incorporated by reference. Other exemplary adhesive zones are also illustrated therein.

Those familiar with the art to which this invention relates will recognize various alternative designs, combinations and embodiments for practicing the invention within the scope of the appended claims.

1-20. (canceled)

21. A method for assembling a frame comprising:
fitting an interconnecting member about a cross member;
applying an adhesive to the cross member and interconnecting member; and
welding the interconnecting member to a side rail at a weld location spaced at least a threshold distance from the adhesive, the threshold distance corresponding to a minimum distance based on test data, wherein at the minimum distance a sensor remained below a threshold temperature during a test weld.

22. The method of claim 21, wherein the test weld comprises positioning thermocouples on a member at a plurality of distances from a test weld location on the interconnecting member, welding the interconnecting member at the test weld location, and monitoring a plurality of temperatures in the thermocouples, and wherein the minimum distance from test data at which a sensor remained below a threshold temperature during a test weld corresponds with the least distance from the test weld location to a thermocouple that remained below the threshold temperature during the test weld.

23. The method of claim 22, wherein positioning thermocouples on a member at a plurality of distances from a test weld location comprises fitting an interconnecting member about a cross member, applying an adhesive to the cross member and interconnecting member, and positioning a plurality of thermocouples on the cross member and interconnecting member.

24. The method of claim 21, wherein the threshold temperature is 400° F.

25. The method of claim 21, wherein the cross member is aluminum and the interconnecting member and rail are steel.

26. The method of claim 21, further comprising crimping together the cross member and interconnecting member to mechanically interlock the cross member and interconnecting member.

27. A method of assembling a vehicle frame, the method comprising:
applying an adhesive to an adhesive zone on at least one of a first tubular member and a second tubular member;
fitting the second tubular member about the first tubular member; and
welding one of the first tubular member and second tubular member to a third tubular member, where the welding comprises selecting a weld line displaced at least a threshold distance from the adhesive zone, the threshold distance corresponding to a minimum distance based upon a rate of heat transfer through the first and second tubular members from the weld line to the adhesive zone.

28. The method of claim 27, wherein the minimum distance based upon a rate of heat transfer is a minimum distance among a set of test measurements at which a temperature remained below a threshold temperature during a test weld.

29. The method of claim 28, wherein the minimum distance among a set of test measurements at which a temperature remained below a threshold temperature during a test weld is a least distance from a test weld location to a thermocouple at which a temperature remained below a threshold temperature during a test weld, where the thermocouple is one of a plurality of thermocouples disposed at a plurality of distances from the test weld location.

30. The method of claim 27, wherein welding one of the first tubular member and second tubular member to a third tubular member comprises welding the second tubular member to the third tubular member, the first tubular member comprising aluminum and the second and third tubular members comprising steel.

31. The method of claim 27, further comprising crimping the first and second tubular members together.

32. A method of testing tubular members, comprising:
selecting a cross member, interconnecting member, and side rail,
fitting the cross member about the interconnecting member;
applying an adhesive to the cross member and interconnecting member;
disposing thermocouples at a plurality of distances from a test weld location, the test weld location being selected to weld the interconnecting member to the side rail;
welding the interconnecting member to the side rail at the test weld location;
monitoring temperatures of the thermocouples at the plurality of distances from the test weld location while welding; and
selecting a weld distance corresponding with the least distance from the weld location to a thermocouple at which a temperature reading remained below a threshold temperature while welding.

33. The method of claim 32, wherein disposing thermocouples at a plurality of distances from a test weld location comprises disposing a plurality of thermocouples on the cross member and interconnecting member.

34. The method of claim 32, wherein disposing thermocouples at a plurality of distances from a test weld location comprises disposing at least one thermocouple within the cross member or interconnecting member.

35. The method of claim 32, wherein disposing thermocouples at a plurality of distances from a test weld location comprises disposing at least one thermocouple on the adhesive.
